(19) United States
(12) Patent Application Publication
(10) Pub. No.: US 2021/0350020 A1
(43) Pub. Date: Nov. 11, 2021

(54) De-identified Identity Proofing Methods and Systems

(71) Applicant: Eiko Onishi, Hong Kong (HK)

(72) Inventor: Eiko Onishi, Hong Kong (HK)

(21) Appl. No.: 16/870,982

(22) Filed: May 10, 2020

(51) Int. Cl. G06F 21/62; H04L 9/32; G06F 21/85; G06F 21/83; G06F 21/60

(52) U.S. Cl. CPC G06F 21/6245; H04L 9/3226; G06F 2221/2149; G06F 21/83; G06F 21/602; G06F 21/85

(57) ABSTRACT

Displaying on a first device a plurality of items in an electronic proofing guide of a corresponding plurality of documents available for identity proofing. The first device receives user input indicative of an item selected from among the plurality of items in the electronic proofing guide, corresponding to a document comprised in the plurality of documents available for identity proofing. In response to receipt of the selection, a selection of the document transmits to a second device paired with a signal comprising at least one of (a) reputation information to be disclosed and (b) a consent to disclosure of said reputation information. In response to receipt of the consent from the second device, an obfuscated version of the reputation information is transmitted to the first electronic device. A data-user electronic device displays the reputation information upon detecting an unlock condition to the obfuscated reputation information.

### FIELD OF THE INVENTION

The subject matter described herein relates to information privacy, and more particularly to managing personally identifiable information.

### BACKGROUND OF THE INVENTION

Identity Theft and Affinity Fraud

Generally, thieves will do things such as contacting the credit card company to change the billing address on their account to avoid detection by the victim. They might also take out loans in the name of another person or write checks using someone else's name and account number. They might also use this information to access and transfer money from a bank account or might even completely take over a victim's identity. In this case, they might open a bank account, buy a car, get credit cards, buy a home, or even find work . . . all by using someone else's identity.

The term identity theft has a very broad definition including misuse of different forms of information, including name, Social Security number, account number, password, or other information linked to an individual other than the one providing it.

Critics have voiced their concerns. First, an identity theft victim cannot sue directly, but must convince a law enforcement agency to investigate the crime. Local law enforcement tends to see identity theft as a “victimless crime”, or a crime that only affects one person, who actually is not “harmed”. But the biggest problem is that a lot of times they identify banks and credit card companies—not individual private citizens, as victims of identity theft that are “directly and proximately harmed” by the infractions. There is no relief provided for the actual victims to recover such expenses as attorneys' fees and costs associated with correcting credit reports.

To understand the problem, you must first realize why thieves want your identity. The answer is simple; they want your credit (money), they want to hide their identity, they want certain services, or they desire employment.

A problem is that synthetic ID theft creates a fragmented or sub-file to your main credit file. A fragmented file refers to additional credit report information tied to your ID card number, but someone else's name and address. Negative information entered in the fragmented file that is then linked to you but doesn't actually belong to you. If you have good credit but there is derogatory information in the fragmented file, it could negatively impact your ability to get credit. Since this type of ID Theft does not affect your main credit file; it often doesn't hit your credit report nor will a fraud alert or credit freeze help. This means it takes longer to find out you've been victimized, making it harder for you to clear your name. When they run up 1000s of dollars of debt and disappear, the creditors will eventually backtrack to you.

With just your id card number, they can create a brand-new identity, an identity that will not be stopped by a fraud alert but will show up in national databases.

The point to remember is that with Synthetic ID Theft is that since it is not your name, address, phone number or credit file . . . credit monitoring, fraud alerts or credit freezes will not inform you or stop synthetic ID theft.

Why Credit Monitoring Services Aren't Much Use to Most Consumers

Most won't tell you if a new wireless or cable service has been taken out in your name.

They do nothing to monitor your bank account transactions, credit card accounts (for fraudulent charges), retirement accounts, brokerage accounts, loyalty accounts and more. And these are all areas where consumers should be very concerned about account takeover.

They do nothing to tell you if a bad guy has hijacked your identity for non-financial purposes, i.e. to get a new driver's license, passport or other identity document. Of course, a bad guy impersonating a consumer using a forged identity document can end up in prison, causing lots of problems for the victim whose identity was hijacked.

They do nothing to stop tax fraud (typically tax refund fraud) against you. Same is true for other government benefit programs, i.e. welfare fraud, Identity card fraud, passport fraud.

If someone takes out a mortgage in your name and now you owe the bank $100 k or more—nobody covers that.

Proper Ownership of Identity

Importantly, if trust in the proper ownership of the identity is predicated on an identification document and the reputation of the document to the claimed identity over time, then what happens if the user loses their identification document or gets a new document? Of course, they will need to start over, to go back through identity proofing—validation, resolution, and verification—from scratch in order to claim their identity on an account again as the owner of the identification document that represents the identity. While legitimate users will need to re-bind authenticators to their identity in such cases, criminals will certainly exploit these account recovery pathways to take over identities because they can bypass the trust and tenure of the established authenticators.

Because identity proofing and authentication are prerequisites to access an account or to conduct a transaction, authentication to an account does not solve the fundamental issue of trust or access that is necessary to grant the individual access to use their identity or, as noted above, to even verify that the identity is real and not synthetic. Additionally, for data schemes where personal information is stored on a smartphone rather than server side, the approach presumes that the individual has a smartphone and is capable of using that smartphone to transmit information. That is before getting into scenarios where devices are shared across multiple members of a household or community.

Identity federation has long held the promise of tying strong authenticators, like a password plus a biometric plus a device, to static bundles of personal information, like a Name, DOB, and SSN, so that the authenticators (the digital login), not the static information, is trusted to represented the identity. Protocols like SAML 2.0 and OAuth 2.0 already enable encrypted assertions and JSON tokens respectively to facilitate sharing of information while RESTful APIs could authenticate a claim—such as a hash of an identity—rather than sharing the raw personal data itself.

Six Data Protection Principles (“DPPs”) of the Personal Data (Privacy) Ordinance.

DPP1—Data Collection Principle

Personal data must be collected in a lawful and fair way, for a purpose directly related to a function/activity of the data user.

Data subjects must be notified of the purpose and the classes of persons to whom the data may be transferred.

Data collected should be necessary but not excessive.

DPP2—Accuracy & Retention Principle

Practicable steps shall be taken to ensure personal data is accurate and not kept longer than is necessary to fulfil the purpose for which it is used.

DPP3—Data Use Principle

Personal data must be used for the purpose for which the data is collected or for a directly related purpose, unless voluntary and explicit consent with a new purpose is obtained from the data subject.

DPP4—Data Security Principle

A data user needs to take practicable steps to safeguard personal data from unauthorized or accidental access, processing, erasure, loss or use.

DPP5—Openness Principle

A data user must take practicable steps to make personal data policies and practices known to the public regarding the types of personal data it holds and how the data is used.

DPP6—Data Access & Correction Principle

A data subject must be given access to his/her personal data and allowed to make corrections if it is inaccurate.

PIPEDA Fair Information Principles

Principle 1—Accountability

An organization is responsible for personal information under its control. It must appoint someone to be accountable for its compliance with these fair information principles.

Principle 2—Identifying Purposes

The purposes for which the personal information is being collected must be identified by the organization before or at the time of collection.

Principle 3—Consent

The knowledge and consent of the individual are required for the collection, use, or disclosure of personal information, except where inappropriate.

Principle 4—Limiting Collection

The collection of personal information must be limited to that which is needed for the purposes identified by the organization. Information must be collected by fair and lawful means.

Principle 5—Limiting Use, Disclosure, and Retention

Unless the individual consents otherwise or it is required by law, personal information can only be used or disclosed for the purposes for which it was collected. Personal information must only be kept as long as required to serve those purposes.

Principle 6—Accuracy

Personal information must be as accurate, complete, and up-to-date as possible in order to properly satisfy the purposes for which it is to be used.

Principle 7—Safeguards

Personal information must be protected by appropriate security relative to the sensitivity of the information.

Principle 8—Openness

An organization must make detailed information about its policies and practices relating to the management of personal information publicly and readily available.

Principle 9—Individual Access

Upon request, an individual must be informed of the existence, use, and disclosure of their personal information and be given access to that information. An individual shall be able to challenge the accuracy and completeness of the information and have it amended as appropriate.

Principle 10—Challenging Compliance

An individual shall be able to challenge an organization's compliance with the above principles. Their challenge should be addressed to the person accountable for the organization's compliance with PIPEDA, usually their Chief Privacy Officer.

GDPR Privacy Principles

1. Lawfulness, fairness, and transparency

2. Purpose limitations

3. Data minimization

4. Accuracy

5. Storage limitation

6. Integrity and confidentiality

### SUMMARY OF THE INVENTION

Claim ID:

1. Register with username, password, ID # of a government-issued document

2. Bring multiple govt-issued documents and vet with any of our assigned institution

3. Download one-time QR code to your mobile and create one-time password

4. Present the QR code to the organizations such as banks/hospitals for your identity verification

5. Bank/hospital receive client's reputation report

6. The report shows ID claim date, vet date, # of identity document vetted, and if there are any other people (potential thefts) has registered the same identity number under other usernames.

### BRIEF DESCRIPTION OF THE DRAWINGS

FIG. 1. Synthetic ID and fragmented records.

FIG. 2. IAL—Identity Assurance Level.

FIG. 3. Identity proofing—lack of identity verification leads to synthetic id and fragmented records.

FIG. 4. Identity verification—alternative online and offline proofing methods.

FIG. 5. Types of identity theft.

FIG. 6. Overview of good practices a data user pledges to implement.

FIG. 7. Open a bank account.

FIG. 8. Fraud alert.

FIG. 9. Exercise Right to Access—to shop at a company that implement good privacy practices.

FIG. 10. Offline mode—verification of reputation information without going through the cloud.

FIG. 11. Partnered data-user helps a data subject builds reputation via vetting.

FIG. 12. Screen—affiliated data-users.

FIG. 13. Screen—privacy notice directory.

FIG. 14. Screen—SAR tracking.

FIG. 15. Claiming multiple personal identifiers.

FIG. 16. Claiming a personal identifier and pairing with a mobile app.

FIG. 17. Using a consent to open a new account via mobile app in online mode.

FIG. 18. Using a consent and an offline reputation to open a new account.

FIG. 19. Report data users who implement poor privacy practice.

FIG. 20. Send privacy requests to data users in hall of shame.

FIG. 21. Manage privacy requests using desktop app.

FIG. 22. Fraud alert when id claimed by more than one data subject.

FIG. 23. Freeze use of personal data.

FIG. 24. Audit data users on behalf of data subjects.

FIG. 25. Propose to data subject options of exercising privacy rights.

FIG. 26. Secure operations module for de-identified proofing and vetting.

FIG. 27. Fraud alert during de-identified proofing and vetting.

### DETAILED DESCRIPTION OF THE INVENTION

Direct marketing is a common business practice. It often involves collection and use of personal data by an organization for direct marketing itself and in some cases, the provision of such data by the organization to another person for use in direct marketing. In the process, compliance with the requirements under privacy laws and regulations is essential. More often than not, it is up to each individual data user to take initiative to follow good practice guidelines and codes of practice. Regulatory frameworks that grant rights of privacy to individuals become too complex for the average consumer to navigate. These firms often productize people's data without rewarding them, yet insidiously expose them to financial risks, identify theft, cyber extortion and fraud, hence the regulatory spiral.

Systems and methods are disclosed herein for people to retain control with their identity and reputation, discover what's going on in the direct marketing, share and express what matters to them, and be rewarded for sharing and expressing their interest and consent.

Examples of good practices affiliated data users (e.g. merchants, non-profit organizations, business and governments) pledge to adhere to for protection of their customers' privacy:
Respect data subject's right of self-determination of his/her own data
Be transparent about whom the direct marketer represents
Give individuals an informed choice of deciding whether or not to allow the use of their personal data in direct marketing
use simple, easily understandable and readable language to present information regarding the collection, use or provision of personal data in a manner that is easily understandable
Inform the data subjects with a reasonable degree of certainty of the classes of marketing subjects
obtain a data subject's consent to use or provision for use of his/her personal data in direct marketing
Provide a means of communication for a data subject to indicate his/her consent to the intended use or provision for use of his/her personal data
Refrain from collecting personal data not normally required for direct marketing purposes.
make known to the customer that it is optional for him to supply the additional data
inform the data subject on or before the collection of his personal data whether it is voluntary or obligatory for him to supply the data, the purpose of use of the data and the classes of persons to whom the data may be transferred
provide further assistance such as help desk or enquiry service to enable the customer to understand the contents of the PICS.
define the class of transferees by its distinctive features
design its service application form in a manner that provides for the customer's agreement to the terms and conditions for the provision of the service to be separated from the customers' consent to the use of his personal data for direct marketing.
Allow customers to indicate separately whether they agree to (i) the use, and (ii) the provision of their personal data to others
Provide information to customers in one self-contained document and avoid making cross-reference to other documents or other sources of information as far as practicable
Inform customers that they may give selective consent to (a) the kinds of personal data; (b) the classes of marketing subjects; and (c) the classes of data transferees
state in a written confirmation a firm's contact information to facilitate the data subject to dispute the confirmation
for the data user to wait for a while (say for example, 14 days) for the data subject to dispute as necessary the written confirmation before (barring such disputes) using the personal data in direct marketing.
confirm, at the time of obtaining the data subject's oral consent, the data subject's contact means (e.g. telephone number to send SMS; correspondence or email address to send text message) to which the written confirmation is to be sent.
If the marketer is an agent making the marketing approach on behalf of the data user, the marketer must communicate an opt-out request to the data user and the data user is expected to make contractual arrangements with the marketing agent to ensure that it receives the opt-out notification.
appropriate application of grandfathering arrangement to the use of the personal data of the data subject in relation to a different class of marketing subjects, purposes, accuracy obligation,
inform the data subject of the intention to use the data for direct marketing
Ensure personal data to be provided falls within the permitted kind of personal data
Ensure the person to whom the data is provided falls within the permitted class of persons
Ensure the marketing subject falls within the permitted class of marketing subjects
the transferor company to assess the adequacy of the personal data protection offered by the partner company
Confine data to be transferred for cross-marketing activities to contact data (e.g. name, address and telephone number), which facilitates the partner company to approach the customer
Avoid in cross-marketing activities the transfer or disclosure of the customer's sensitive data such as credit card number and/or Identity Card number to the partner company
the transferor company undertakes compliance audits or reviews regularly to ensure that the customers' personal data transferred is only used for the purpose of carrying out the agreed cross-marketing activities and the transferee company has taken appropriate data protection measures in compliance with all applicable laws and regulations.
inform the data subjects of the source of the personal data held by them in order to help data subjects to exercise their opt-out rights against direct marketing approaches more effectively by tackling the problem at its root instead of rejecting individual direct marketing approaches as they arise

Systems and methods are disclosed herein to facilitate verification of pledges from data users of adhering to good practices for protection of their customers' privacy.

Systems and methods are disclosed herein to give data subjects a choice to shop at data users who best protect personal data.

Systems and methods are disclosed herein to give data subjects tools to build reputation, and to retain control of it thereafter.

At a high level, identity proofing of an individual is a three step process consisting of (1.) identity resolution (confirmation that an identity has been resolved to a unique individual within a particular context, i.e., no other individual has the same set of attributes), (2.) identity validation (confirmation of the accuracy of the identity as established by an authoritative source) and, (3.) identity verification (confirmation that the identity is claimed by the rightful individual).

A general identity framework using authenticators, credentials, and assertions together in a digital system
Identity Assurance Level (IAL): the identity proofing process and the binding between one or more authenticators and the records pertaining to a specific subscriber
Authenticator Assurance Level (AAL): the authentication process, including how additional factors and authentication mechanisms can impact risk mitigation
Federation Assurance Level (FAL): the assertion used in a federated environment to communicate authentication and attribute information to a relying party (RP)

Systems and methods are needed for resolving an identity to a single person and enables RPs to evaluate and determine the strength of identity evidence. No longer will it be sufficient for organizations to ask for “one government-issued ID and a financial account.” The proofing process moves away from a static list of acceptable documents and instead describes “characteristics” for the evidence necessary to achieve each IAL. Organizations can now pick the evidence that works best for their customers.

Hackers can't steal what you don't have. Systems and methods disclosed herein verify identifications without collecting or sending any of your private information. In fact, using a “less is more” approach, a data subject will not even provide any name or phone number to our system. This is part of the practice known as data minimization. Data minimization refers to the practice of limiting the collection of personal information to that which is directly relevant and necessary to accomplish a specified purpose. Data minimization standard operating procedure to minimize risk. The less personal information an organization collects and retains, the less personal information will be vulnerable to data security incidents. Only effectively de-identified data will be used for the verification of your identification.

Turning Privacy Rights into Tools and Action

1. Practicable Steps for Data Users to Take to Verify Customers' Identification.

Applicable laws and regulations include at least: Data Protection Principle 2—Practicable steps shall be taken to ensure personal data is accurate, and Data Protection Principle 4—A data user needs to take practicable steps to safeguard personal data from unauthorized or accidental access, processing, erasure, loss or use. Equipped with tools and technologies that leverage privacy rights for individuals, data subjects are now in better positions to demand strong identity proofing practice from data users, utilizing one or more official documents and/or government-issued ID to assure a data subject's identity.

2. Practicable Steps for Data Users to Take to Safeguard Claims of Stolen Identities.

Applicable laws and regulations include at least: Data Protection Principle 1(2)(b)—Personal data must be collected in a lawful and fair way, Data Protection Principle 2—Practicable steps shall be taken to ensure personal data is accurate; Data Protection Principle 4—A data user needs to take practicable steps to safeguard personal data from unauthorized or accidental access, processing, erasure, loss or use. Equipped with tools and technologies that leverage privacy rights for individuals, data subjects are now in better positions to demand strong identity proofing practice from data users, safeguard unauthorized claims of identities, e.g. possibly stolen from their rightful owners.

3. Promote Data Users Who Implement Good Privacy Practices.

Promote data users that keep the public's personal data safe and private. Shame data users on questionable practices. Applicable laws and regulations include at least: Data Protection Principle 6—A data user must take practicable steps to make personal data policies and practices known to the public regarding the types of personal data it holds and how the data is used.

4. Putting Data Subjects in the Driver's Seat in the Economy of Tomorrow.

By leveraging personal data and giving consent to their use, data subjects will get to decide the permitted class of persons, permitted class of marketing subjects, and permitted kind of personal data. Good privacy practices turn into a consumer choice.

De-Identified Proofing Methods and Systems

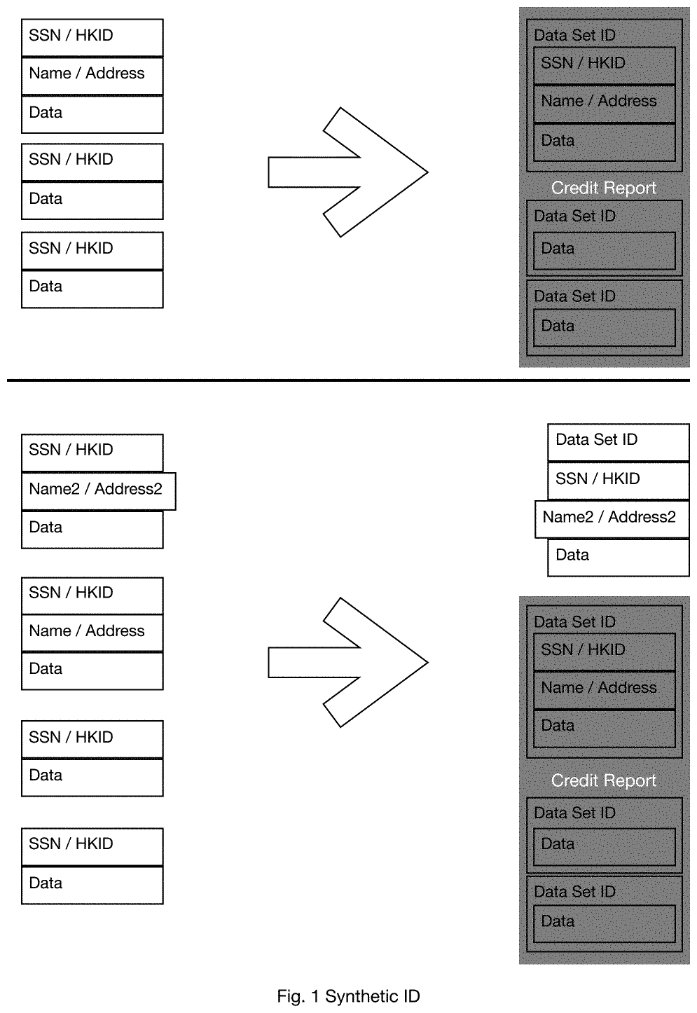

In FIG. 1, a problem is that synthetic ID theft creates a fragmented or sub-file to a data subject's main credit file. A fragmented file refers to additional credit report information tied to a data subject's ID card number, but someone else's name and address.

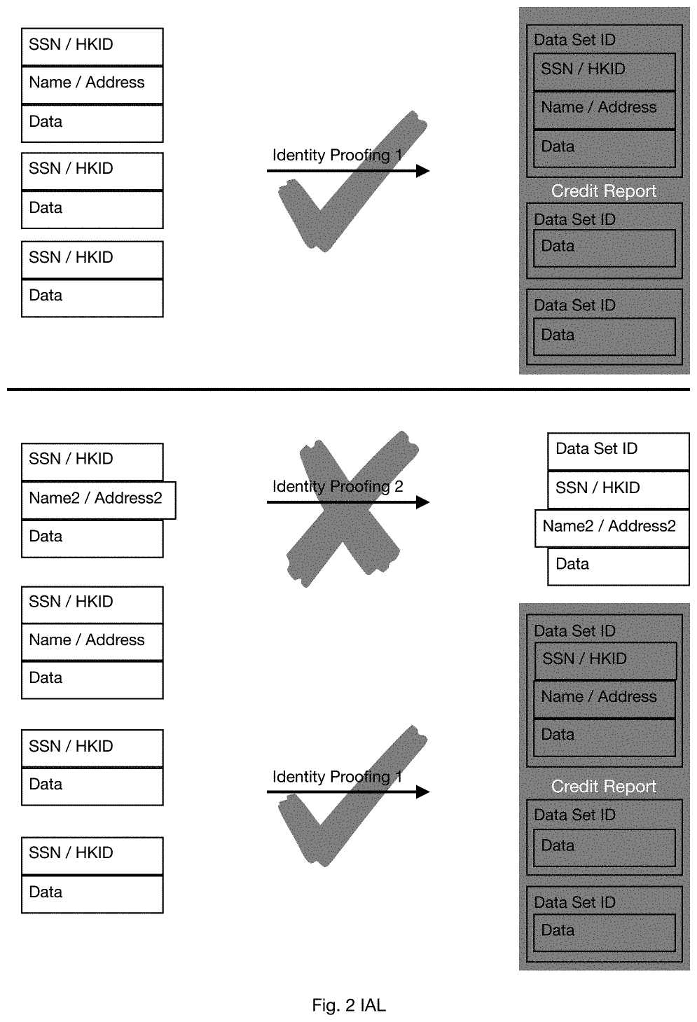

In FIG. 2, the identity proofing process and the binding between one or more authenticators and the records pertaining to a specific data user.

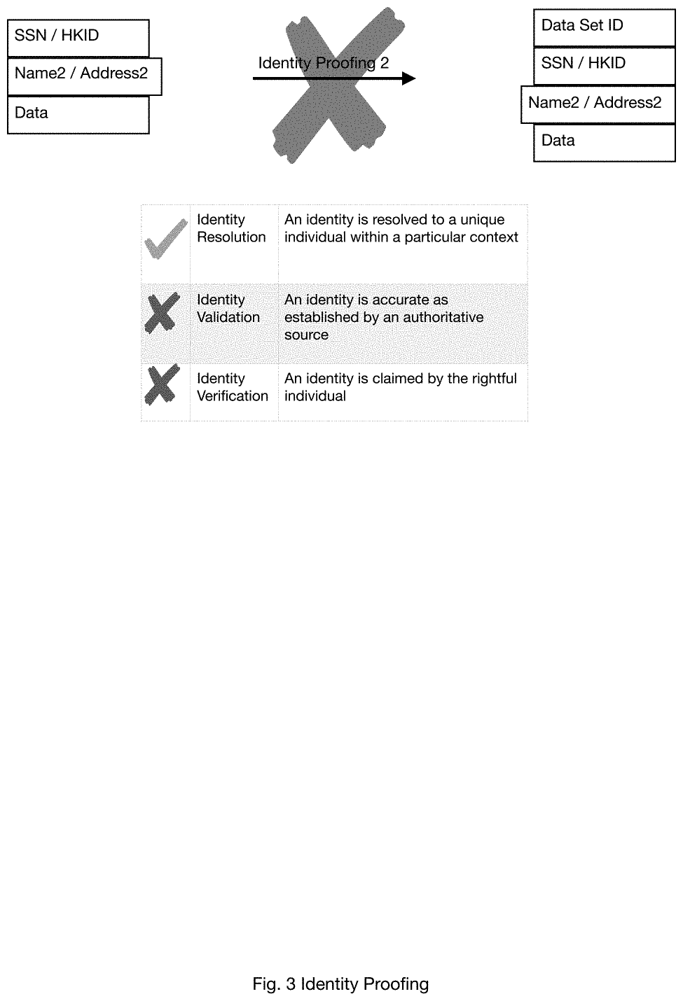

In FIG. 3, at a high level, identity proofing of an individual is a three step process consisting of (1.) identity resolution (confirmation that an identity has been resolved to a unique individual within a particular context, i.e., no other individual has the same set of attributes), (2.) identity validation (confirmation of the accuracy of the identity as established by an authoritative source) and, (3.) identity verification (confirmation that the identity is claimed by the rightful individual). Insecure and/or insufficient identity verification methods has been one of the leading causes of identity theft today.

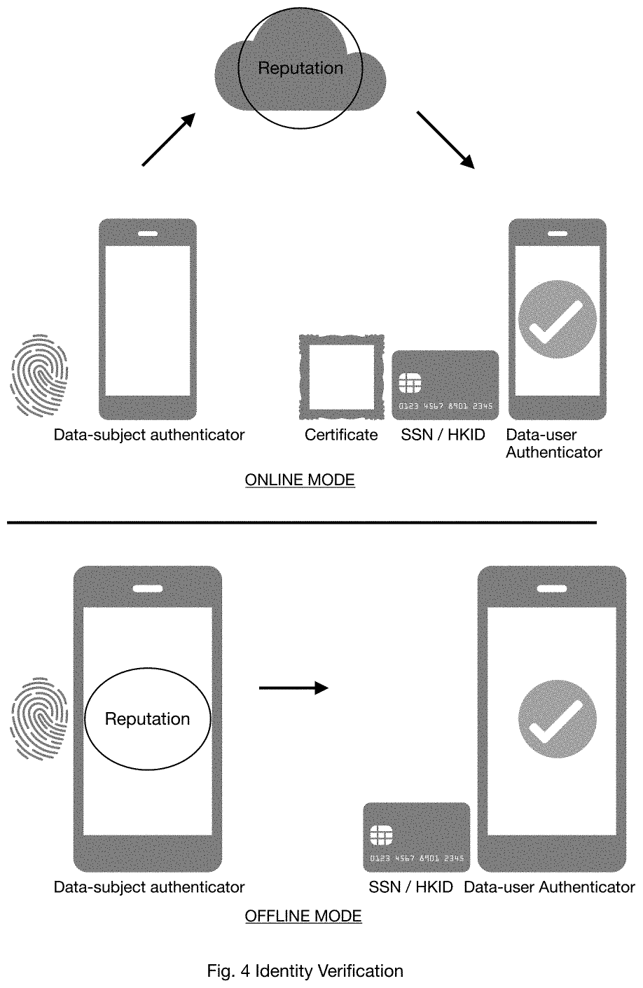

In FIG. 4, In online mode, data-user device obtains a consent from a data-subject device, transmits the consent to the computer system in the Cloud to obtain an obfuscated version of reputation information of the associated data subject; whereas in offline mode, data-user device obtains the obfuscated reputation information from the data-subject device instead. For the purpose of authentication, one option is to make use of a preinstalled PKI certificate to verify the authenticity of the obfuscated reputation information.

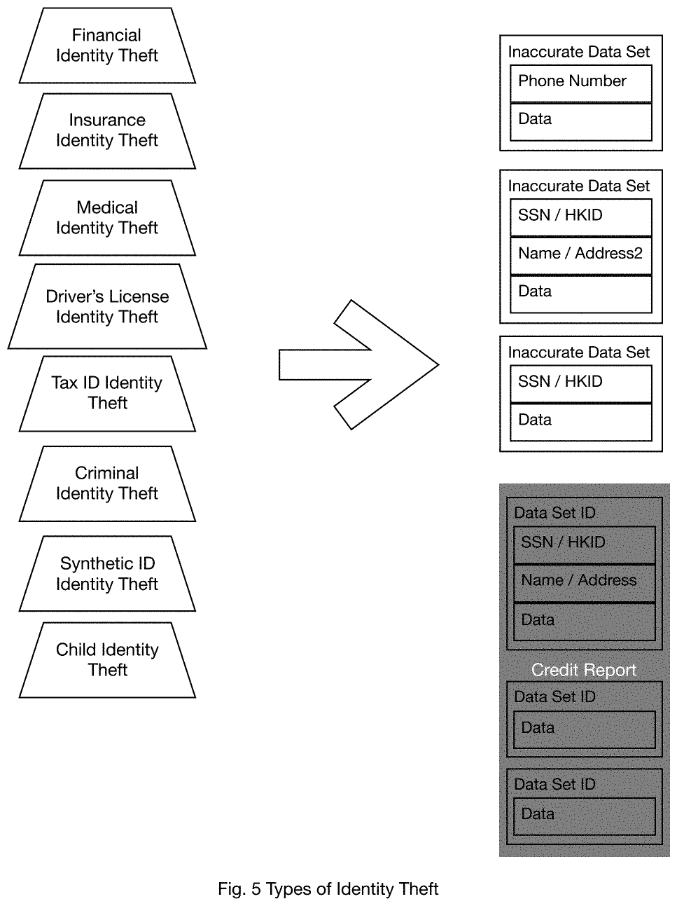

In FIG. 5, Examples of identity theft that lead to personal record fragmentation.

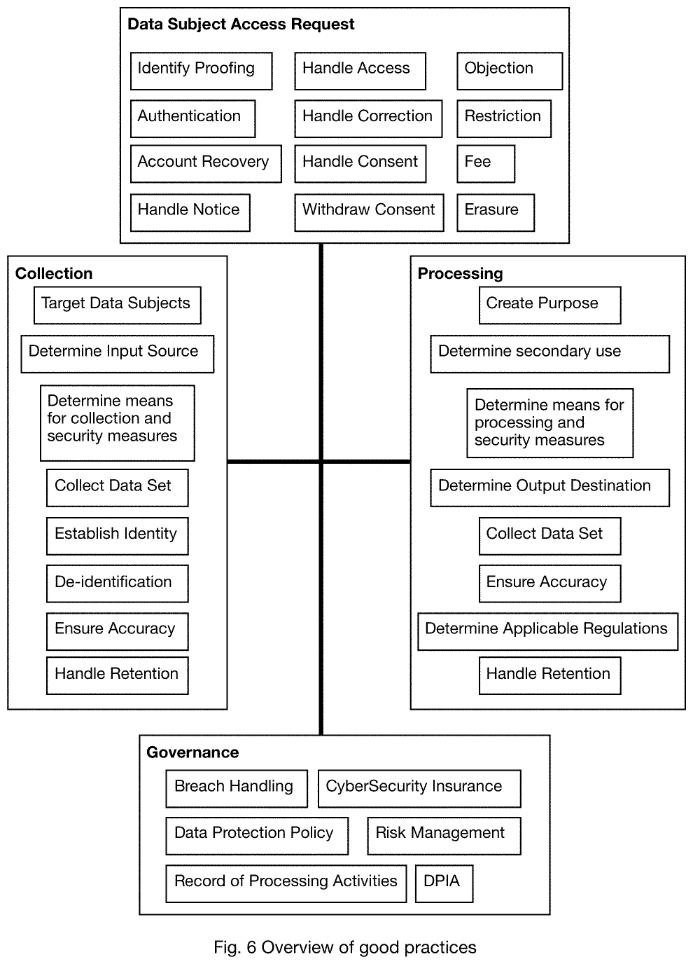

In FIG. 6, Examples of good practices affiliated data users who pledge to adhere to for protection of their customers' privacy.

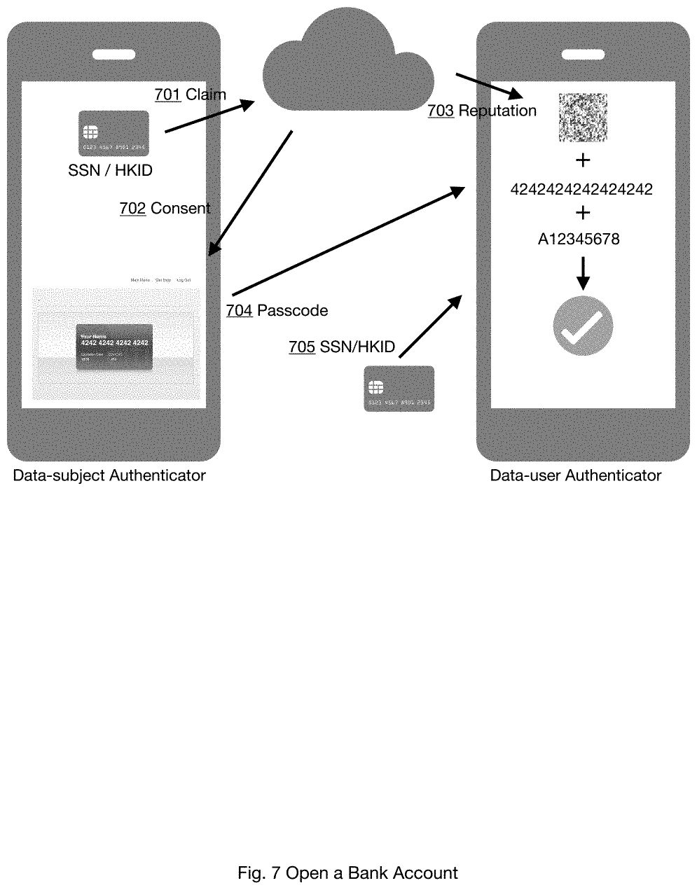

In FIG. 7. In step 701, a registered data subject claims ownership of an identification document. In step 702, the system sends a consent along with a passcode to a paired data-subject mobile app. In response, the data-subject mobile app displays a reputation in good standing. In step 703, a data-user device submits the consent to the cloud, and in response obtains a reputation information according to the consent. In step 704 and 705, the data subject presents the passcode and the identification document to the data user, who in turn enters the passcode and the document id into the data-user mobile app to unlock access to the reputation information.

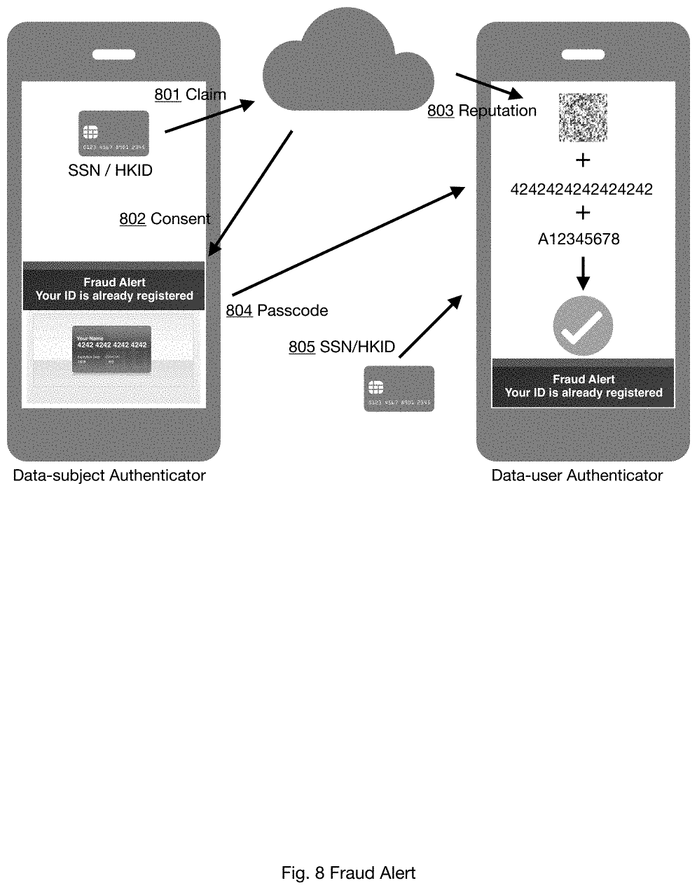

In FIG. 8. In step 801, a registered data subject claims ownership of an identification document. In step 802, the system sends a consent along with a passcode to a paired mobile app. In response, the data-subject mobile app displays a fraud alert to indicate the same identification document is being claimed by more than one registered data subject. In step 803, a data-subject device obtains a reputation information according to the consent. In step 804 and 805, the data subject presents the passcode and the identification document to the data user, who in turn enters the passcode and the document id into the data-user mobile app to unlock access to the reputation information. The data-user mobile app additionally displays a fraud alert to indicate the same identification document is being claimed by more than one registered data-subjects.

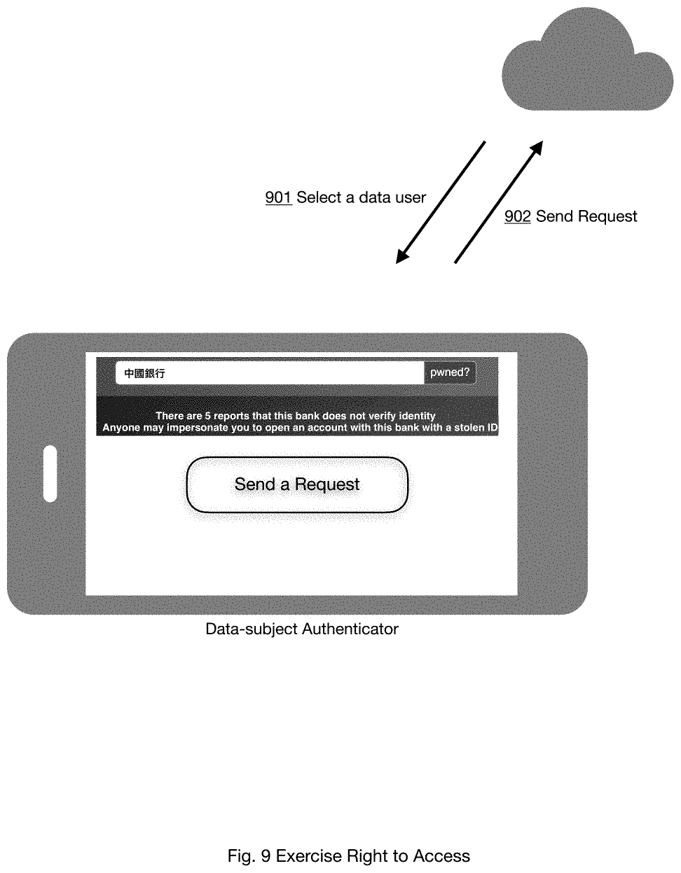

In FIG. 9. In step 901, a registered data subject selects a data user for rating purpose. Subsequently, rating information of that data user is being displayed on the data-subject mobile app. In step 902, the data subject initiates a subject access request via the data-subject mobile app to obtain additional privacy information.

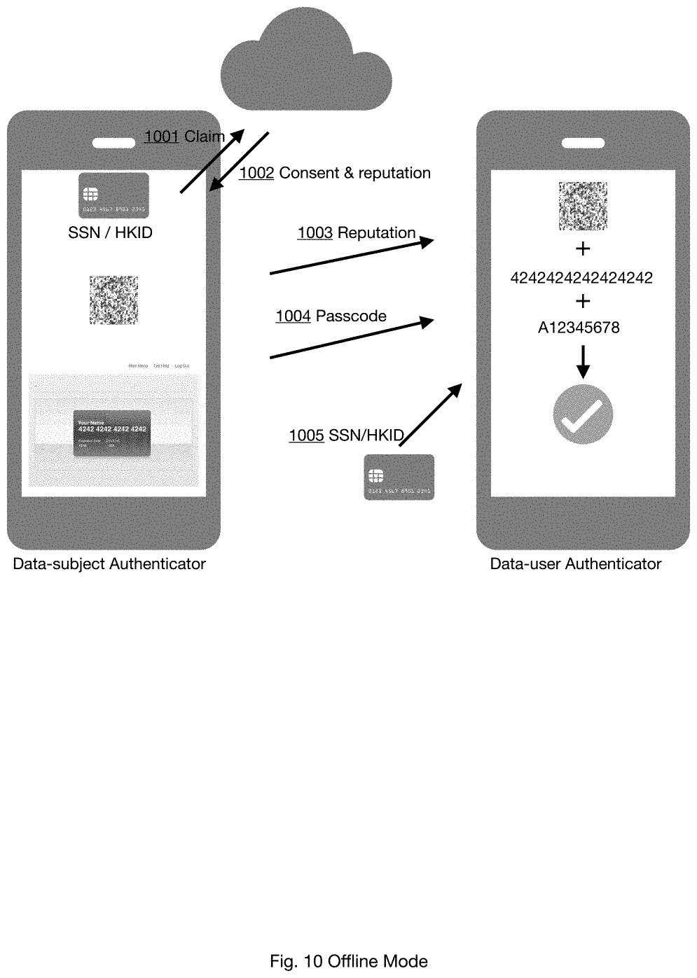

In FIG. 10. In step 1001, a registered data subject claims ownership of an identification document. In step 1002, the system sends a consent, an obfuscated reputation information, and a passcode to a paired mobile app. In response, the data-subject mobile app displays the reputation information in good standing. In step 1003, a data-user device obtains from the data-subject mobile app the obfuscated reputation information. In step 1004 and 1005, the data subject presents the passcode and the identification document to the data subject, who in turn enters the passcode and the document id into the data-user device to unlock access to the reputation information.

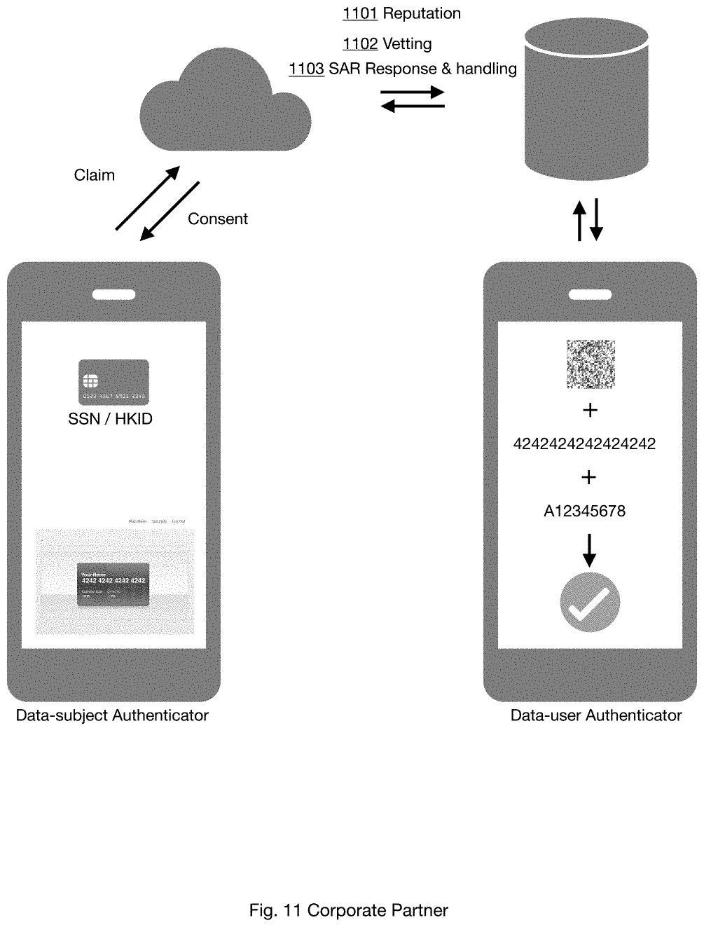

In FIG. 11. A registered data subject claims ownership of an identification document, obtains a consent along with a passcode to a paired mobile app. In step 1101, a data-user device obtains the consent from the data-subject mobile app, submits to the Cloud to obtain an obfuscated reputation information, and successfully unlocks the reputation information by applying the passcode along with the document ID. In step 1102, the data user submits a successful vetting result to the Cloud. In step 1103, the data user handles additional access requests from the registered data subject regarding the use and disclosure of the personal data.

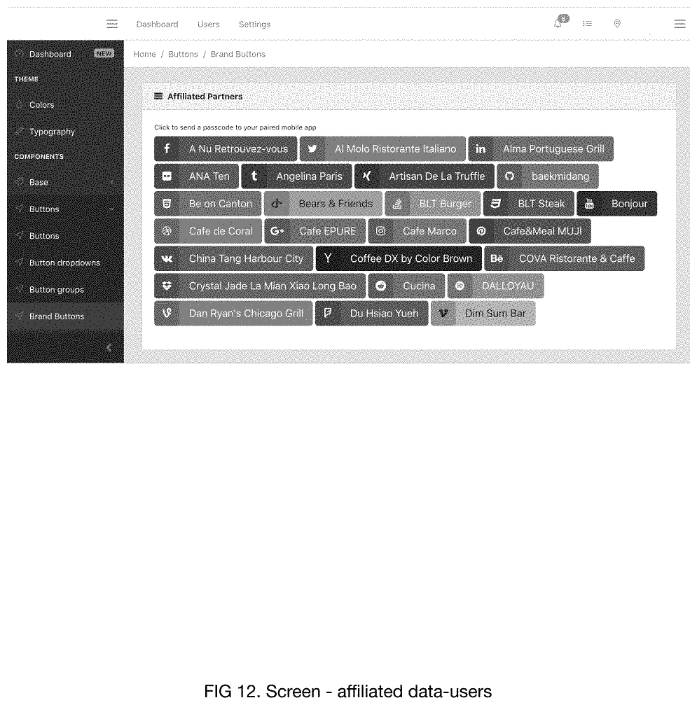

In FIG. 12. A list of partnered data-users is readily available to assist a data subject with privacy inquiries via a streamlined process available from the desktop app.

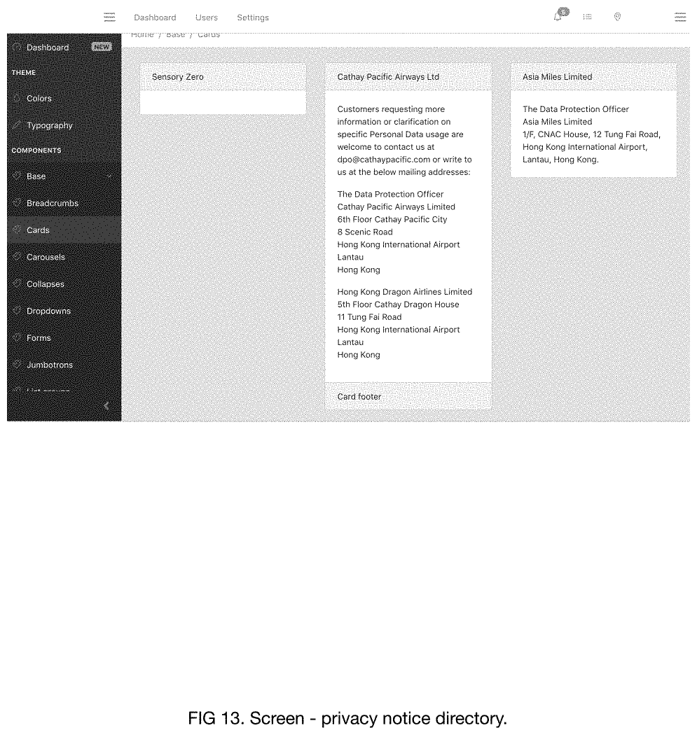

In FIG. 13. As part of a streamline process, our system automatically gathers privacy notices and contact information to provide in one central location for ease of use by data subjects to reach out to data users.

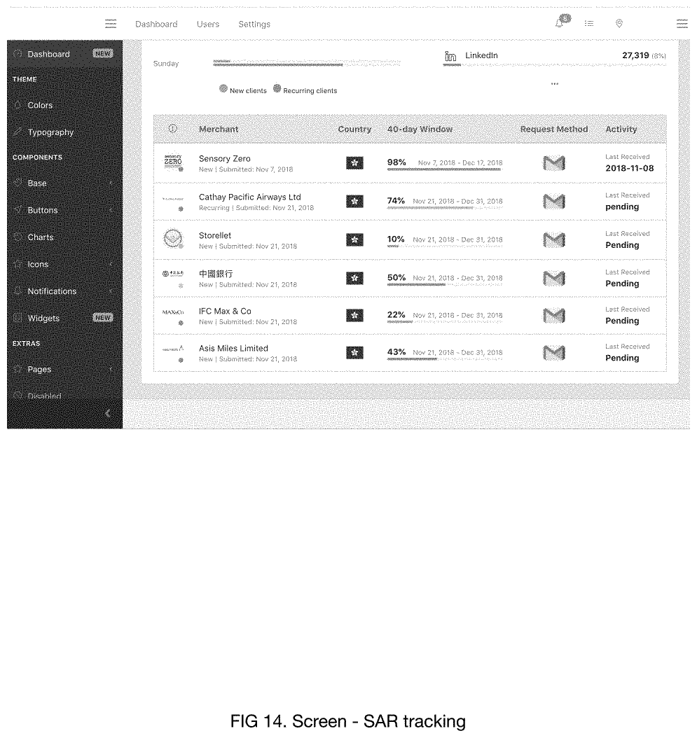

In FIG. 14. Data subjects may make use of our systems to send access requests to data users, keep track of progress and response, and reply directly via our systems.

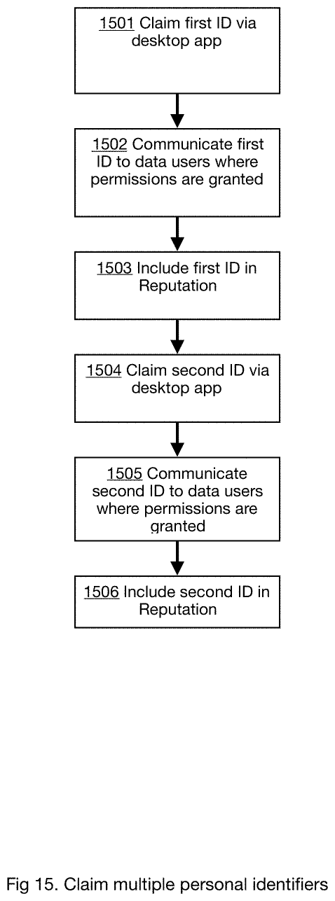

In FIG. 15. In Step 1501, Data subject claims first ID via desktop app. In Step 1502, the system communicates first ID to data users where permissions are granted. In Step 1503, the system includes the first ID in reputation. In Step 1504, the data subject claims a second ID via desktop app. In Step 1505, the system communicates the second ID to data users where permissions are granted. In Step 1506, the system includes the second ID in reputation.

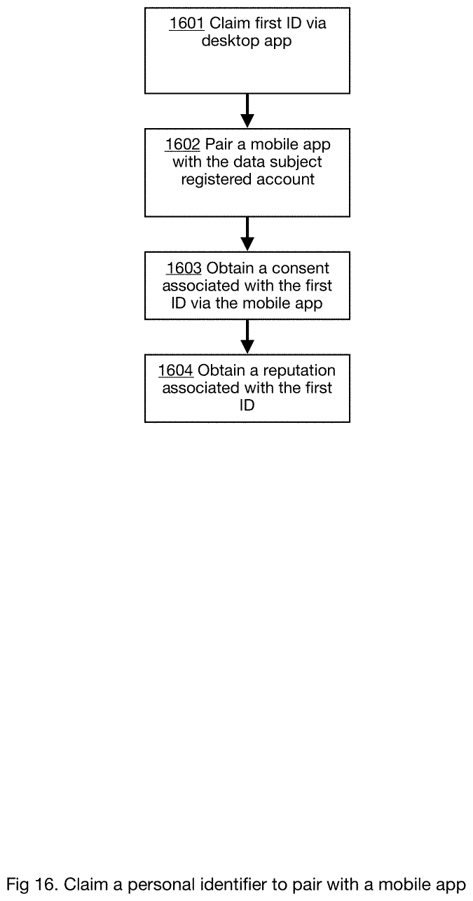

In FIG. 16. In Step 1601, data subject claims first ID via desktop app. In Step 1602, data subject pairs a mobile app with the data subject's registered account. In Step 1603, data subject obtains a consent associated with the first ID via the mobile app. In Step 1604, data subject obtains a reputation associated with the first ID.

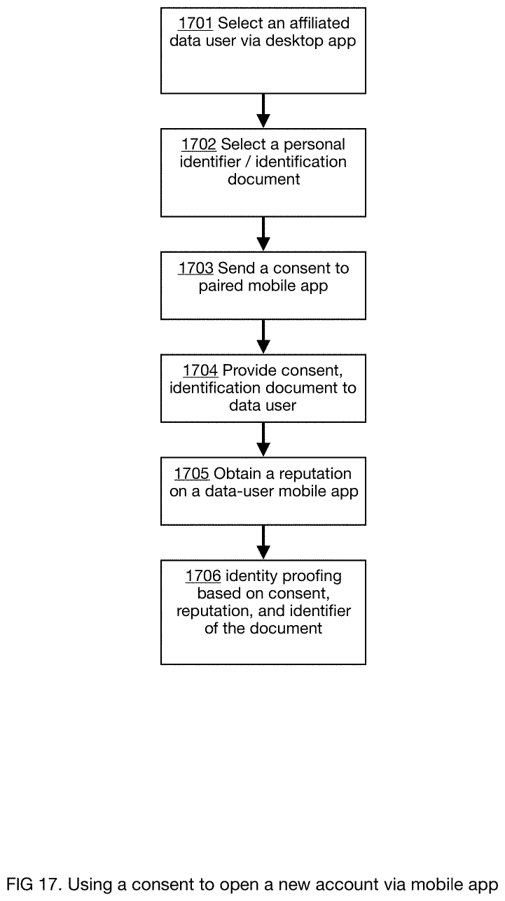

In FIG. 17. In Step 1701, data subject selects an affiliated data user via desktop app. In Step 1702, data subject selects a personal identifier/identification document. In Step 1703, the system sends a consent to paired mobile app. In Step 1704, data user exchanges the consent with a reputation information on a data-user mobile app. In Step 1705, data subject provides consent, identification document to data user. In Step 1706, data user performs identity proofing based on consent, reputation, and identifier of the document.

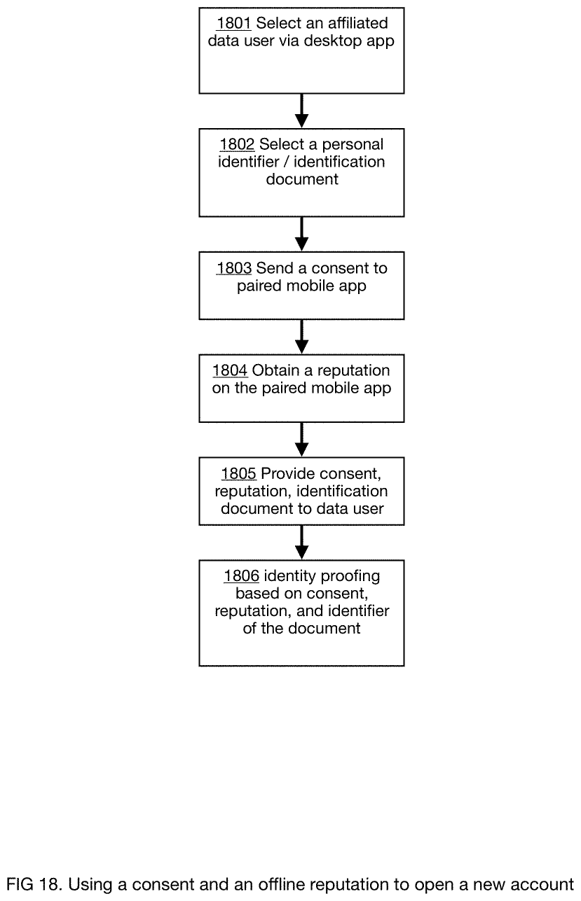

In FIG. 18. In Step 1801, data subject selects an affiliated data user via desktop app. In Step 1802, data subject selects a personal identifier/identification document. In Step 1803, the system sends a consent to a paired mobile app. In Step 1804, data subject obtains a reputation on the paired mobile app. In Step 1805, data subject provides consent, reputation, and identification document to data user. In Step 1806, data user performs identity proofing based on consent, reputation, and identifier of the document.

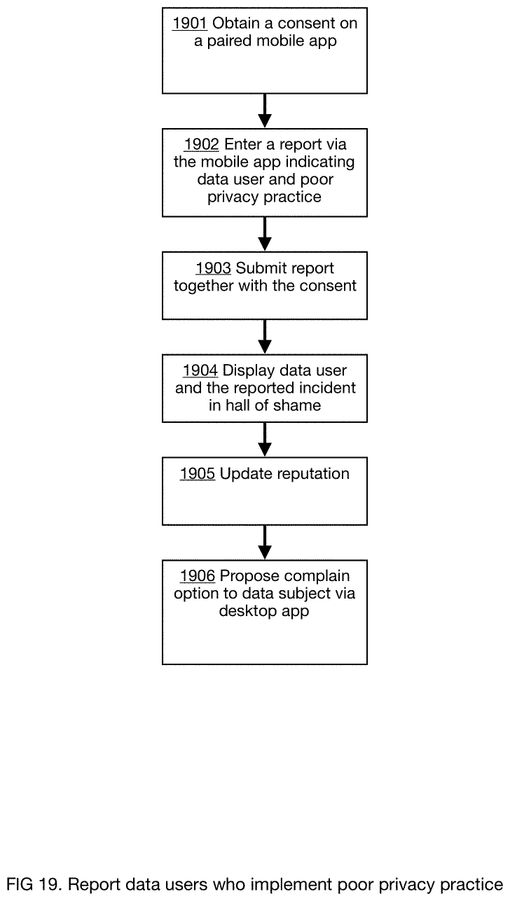

In FIG. 19. In Step 1901, data subject obtains a consent on a paired mobile app. In Step 1902, data subject enters a report via the mobile app indicating data user and poor privacy practices. In Step 1903, data subject submits a report along with the consent. In Step 1904, the system displays the data user and the reported incident in a hall of shame. In Step 1905, the system updates the data subject's reputation. In Step 1906, the system proposes complain options to the data subject via desktop app.

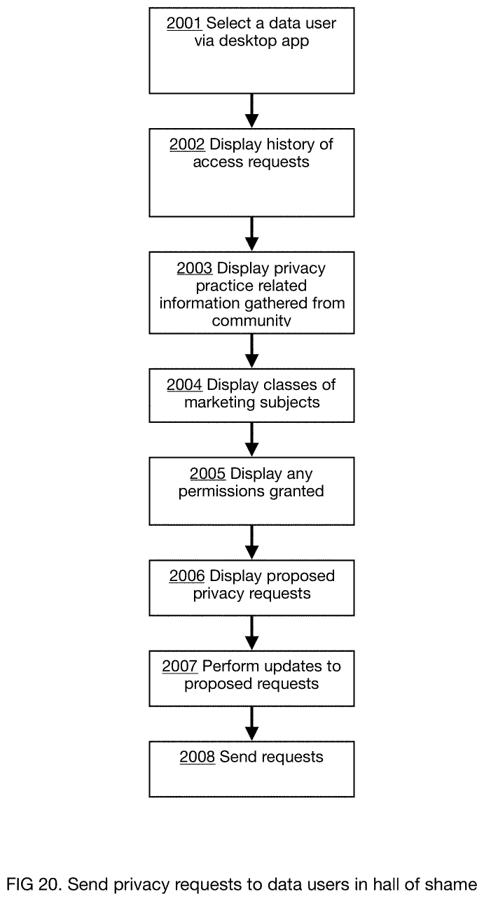

In FIG. 20. In Step 2001, data subject selects a data user via desktop app. In Step 2002, the system displays history of access requests. In Step 2003, the system displays privacy practice and related information gathered from the community at large. In Step 2004, the system displays classes of marketing subjects. In Step 2005, the system displays any permissions granted. In Step 2006, the system displays proposed privacy requests. In Step 2007, the system performs updates to proposed requests. In Step 2008, the system sends requests.

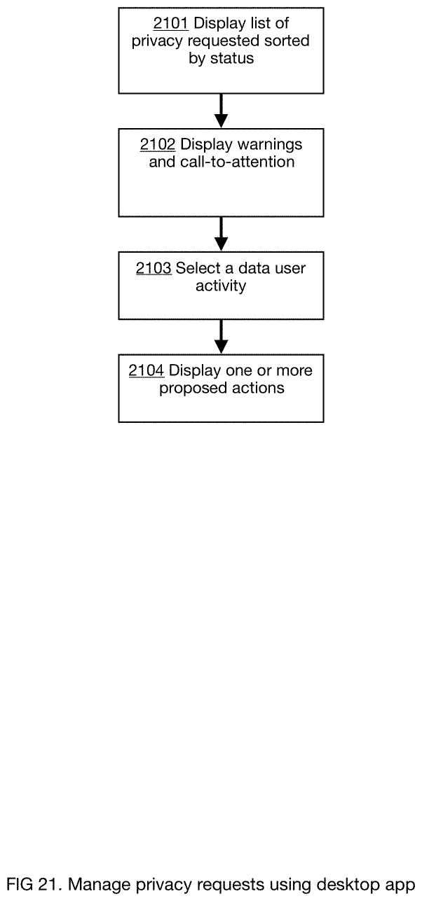

In FIG. 21. In Step 2101, the system displays a list of privacy requests sorted by status. In Step 2102, the system displays warnings and call-to-attention. In Step 2103, data subject selects activities in relation to a data user. In Step 2104, the system displays one or more proposed actions.

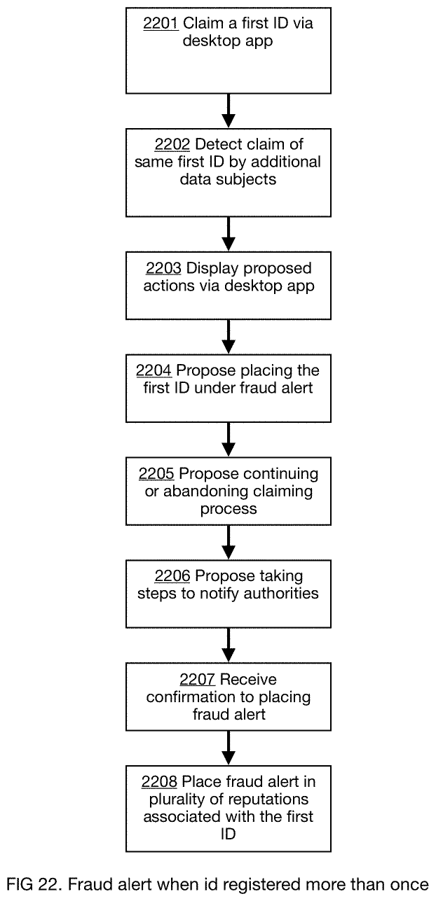

In FIG. 22. In Step 2201, data subject claims a first ID via desktop app. In Step 2202, the system detects if the same first ID is being claimed by one or more data subjects. In Step 2203, the system displays proposed actions via desktop app. In Step 2204, the system proposes placing the first ID under fraud alert. In Step 2205, the system proposes continuing or abandoning the claiming process. In Step 2206, the system proposes taking steps to notify authorities. In Step 2207, the system receives confirmation from data subject to placing a fraud alert. In Step 2208, the system places a fraud alert in plurality of reputations associated with the first ID.

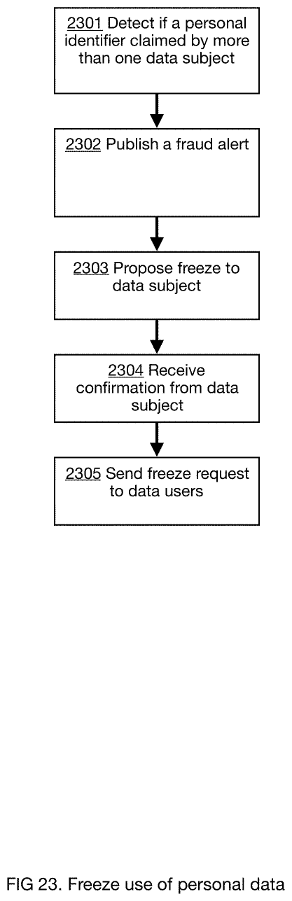

In FIG. 23. In Step 2301, the system detects if a personal identifier is being claimed by more than one data subject. In Step 2302, the system issues a fraud alert. In Step 2303, the system proposes freeze options to the data subject. In Step 2304, the system receives confirmation from the data subject. In Step 2305, the system sends freeze requests to data users.

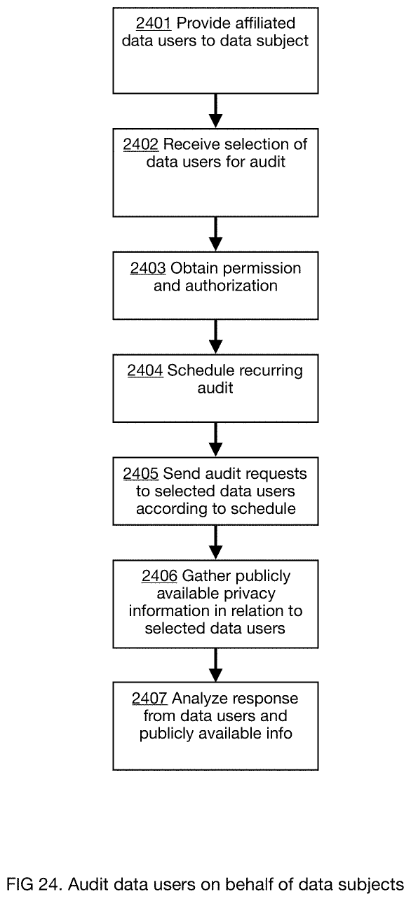

In FIG. 24. In Step 2401, the system provides affiliated data users to a data subject. In Step 2402, the system receives selection of data users for audit. In Step 2403, the system obtains permission and authorization from data subject. In Step 2404, data subject schedules recurring audit. In Step 2405, the system sends audit requests to selected data users according to schedule. In Step 2406, the system gathers publicly available privacy information in relation to selected data users. In Step 2407, the system analyzes responses from data users and publicly available info.

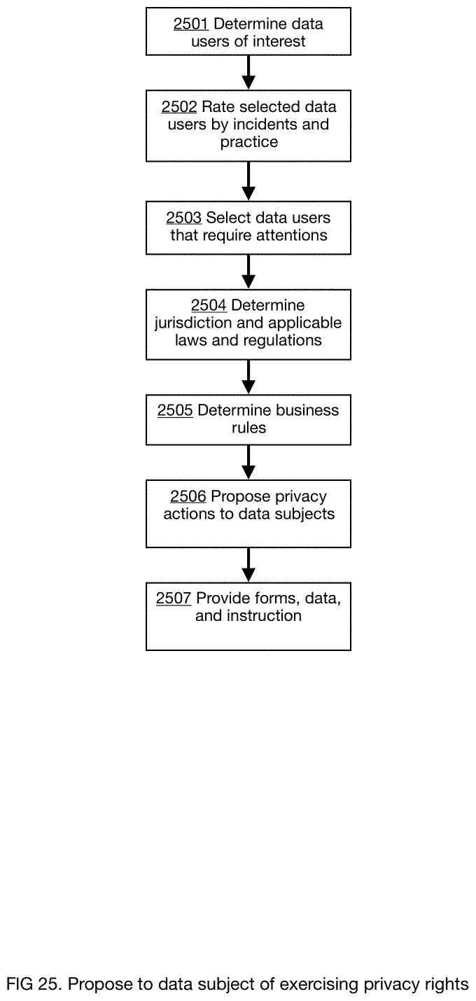

In FIG. 25. In Step 2501, the system determines data users of interest. In Step 2502, the system rates selected data users by incidents and practice. In Step 2503, data subject selects data users that require attention. In Step 2504, the system determines jurisdiction and applicable laws and regulations. In Step 2505, the system determines business rules. In Step 2506, the system proposes privacy actions to data subjects. In Step 2507, the system provides forms, data, and instruction to the data subject.

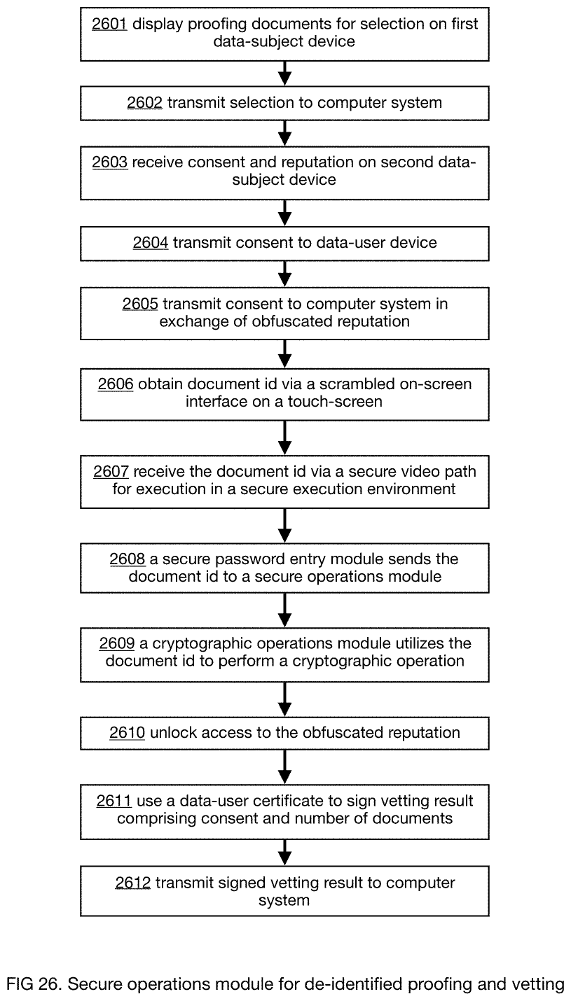

In FIG. 26, In step 2601, the system displays proofing documents for selection on a first data-subject device. In Step 2602, data subject makes selection, and the selection is transmitted to the cloud computer. In Step 2603, a second data-subject device receives a consent and reputation in response from the cloud computer. In Step 2604, the second data-subject device transmits the consent to a data-user device. In Step 2605, the data-user device subsequently transmits the consent to the cloud computer and receives obfuscated reputation information in return. In Step 2606, the data user enters the document id to the data-user device via a scrambled on-screen interface generated on a touch-screen. In Step 2607, the document id is received into a secure execution environment via a secure video path that links to the touch-screen. In Step 2608, a secure password entry module in the secure execution environment sends the document id to a secure operations module, wherein in Step 2609 and 2610 a cryptographic operations module utilizes the document id to perform a cryptographic operation associated with unlocking the obfuscated reputation information. In Step 2611, the data subject presents one or more official identification documents and/or government-issued documents. The result is vetted by the data user to confirm the association between the documents and the data subject, entered into the data-user mobile app for digital signing. In Step 2612, the data-user mobile app transmits the vetted result to the computer system in the cloud.

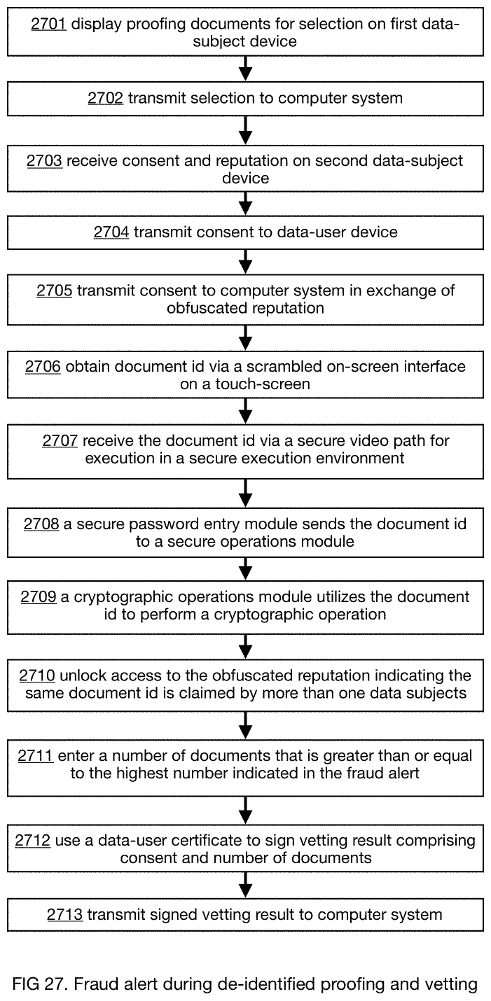

In FIG. 27, in step 2701 the system displays proofing documents for selection on a first data-subject device. In Step 2702, data subject makes selection, and the selection is transmitted to the cloud computer. In Step 2703, a second data-subject device receives a consent and reputation in response from the cloud computer. In Step 2704, the second data-subject device transmits the consent to a data-user device. In Step 2705, the data-user device subsequently transmits the consent to the cloud computer and receives obfuscated reputation information in return. In Step 2706, the data user enters the document id to the data-user device via a scrambled on-screen interface generated on a touch-screen. In Step 2707, the document id is received into a secure execution environment via a secure video path that links to the touch-screen. In Step 2708, a secure password entry module in the secure execution environment sends the document id to a secure operations module, wherein in Step 2709 and 2710 a cryptographic operations module utilizes the document id to perform a cryptographic operation associated with unlocking the obfuscated reputation information. In Step 2711, the data subject presents one or more official identification documents and/or government-issued documents. For the purpose of vetting in the presence of a fraud alert, the number of documents should be no less than the highest number indicated in the fraud alert. In Step 2712, the result is vetted by the data user to confirm the association between the documents and the data subject, entered into the data-user mobile app for digital signing. In Step 2713, the data-user mobile app transmits the vetted result to the computer system in the cloud.

1. A method of displaying reputation information on a data-user electronic device and on a first data-subject device, using a computer system coupled to at least the data-user electronic device, the computer system comprising a computer, each of the computer, the first data subject device and the data-user electronic device comprising at least a processor and a memory, the method comprising:
the first data-subject device displaying a plurality of items in an electronic proofing guide, of a corresponding plurality of documents available for identity proofing on the data-user electronic device;
the first data-subject device receiving first user input indicative of an item selected from among the plurality of items in the electronic proofing guide, corresponding to a document comprised in the plurality of documents available for identity proofing;
the first data-subject device transmitting to the computer system, a selection of the document;
in response to receipt of the selection, the computer system transmitting to a second data-subject device paired with the selected document, a signal comprising at least one of (a) reputation information to be disclosed and (b) a consent to disclosure of said reputation information;
the second data-subject device transmitting to the data-user electronic device, the consent to disclosure of said reputation information;
the data-user electronic device transmitting to the computer system, the consent to disclosure of said reputation information;
In response to receipt of the consent from the data-user electronic device, the computer system transmitting to the data-user electronic device, an obfuscated version of the reputation information;
the data-user electronic device detecting an unlock condition based on a second user input that is received at a second input mechanism, wherein the data-user electronic device is configured to interpret the second user input as a password for unlocking access to the obfuscated reputation information; and
in response to said detecting, the data-user electronic device automatically displaying on a screen therein, the reputation information on receipt thereof from the computer system.

2. The method of claim 1, wherein the second user input comprises a cryptographic key.

3. The method of claim 1, wherein the second user input comprises a value that uniquely identifies the selected document.

4. The method of claim 1, wherein the consent is characterized by absence of any variables that allow for re-identification.

5. The method of claim 4, wherein
the variables comprise at least one of name, address and phone number of a data subject;
the reputation information is characterized by absence of any variables that allow for re-identification;
the variables comprise at least one of name, address and phone number of a data subject;
the reputation information comprises at least one of:
a fraud alert indicating the selected document is being claimed by a plurality of data subjects; and
highest number of documents vetted among the plurality of data subjects;
the data-user electronic device digital signing a vetting request that comprises the consent and a count of proofing documents, and sending the signed request to the computer system; and
the first data-subject device and the second data subject device are the same device.

6. A data-user electronic device comprising:
a secure execution environment to securely execute code; and
a secure video path to securely exchange information between the secure execution environment and a touch-screen of the data-user electronic device;
wherein the secure execution environment comprises a secure password entry module to generate a scrambled on-screen interface, and to send the scrambled on-screen interface to the touch-screen through the secure video path.

7. The data-user electronic device of claim 6, further comprising:
a secure operations module to securely receive, from the secure password entry module, a cryptographic key entered by a user via said touch-screen; and
a cryptographic operations module to utilize the cryptographic key received through the secure operations module for performing a cryptographic operation associated with unlocking access to obfuscated reputation information.

8. The data-user electronic device of claim 7, wherein the cryptographic operation comprises at least one of:
encryption using the cryptographic key; and
decryption using the cryptographic key.

9. The data-user electronic device of claim 8, further comprising:
a visual indicator to indicate to a user that access to the obfuscated reputation information is unlocked and that the user can reveal the reputation information through the touch-screen.

10. The data-user electronic device of claim 8, wherein the cryptographic operation comprises:
digital signing a vetting request comprising a consent and a count of proofing documents; and
sending the signed request for vetting at a vetting module external to the data-user electronic device.
